(19) United States
(12) Patent Application Publication
(10) Pub. No.: US 2024/0199483 A1
(43) Pub. Date: Jun. 20, 2024

(54) GEOPOLYMER FOAMS BASED ON CERAMIC MATERIALS

(71) Applicant: SIKA TECHNOLOGY AG, Baar (CH)

(72) Inventors: Manuel HAMBACH, Trostberg (DE); Nils MOHRI, Trostberg (DE)

(73) Assignee: SIKA TECHNOLOGY AG, Baar (CH)

(21) Appl. No.: 18/287,278

(22) PCT Filed: Apr. 20, 2022
(86) PCT No.: PCT/EP2022/060454

§ 371 Date: Oct. 17, 2023

(30) Foreign Application Priority Data
Apr. 24, 2021 (EP) 21170328.5

(51) Int. Cl. C04B 12/00; C04B 18/02; C04B 18/165; C04B 28/00; C04B 38/10; C04B 111/40

(52) U.S. Cl. CPC C04B 12/005; C04B 18/025; C04B 18/165; C04B 28/006; C04B 38/103; C04B 2111/40

(57) ABSTRACT

As geopolymer foam formulation including an inorganic binder, a ceramic material, an alkaline activator, an alkyl polyglucoside, a gas phase and water. Moreover, a process for the manufacture of such formulation by means of mechanical and/or chemical foaming as well as to a process for the manufacture of a hardened geopolymer foam therefrom. Also, a geopolymer foam element including the hardened geopolymer foam. Finally, the use of ceramic materials for substituting fly ashes in geopolymer foam formulations. The ceramic material is preferably brick dust.

The present invention relates to a geopolymer foam formulation comprising an inorganic binder, a ceramic material, i.e. a pulverulent burnt clay material, an alkaline activator, an alkyl polyglucoside, a gas phase and water. Moreover, it relates to a process for the manufacture of such formulation by means of mechanical and/or chemical foaming as well as to a process for the manufacture of a hardened geopolymer foam therefrom. It also relates to a geopolymer foam element comprising said hardened geopolymer foam. Finally, the present invention relates to the use of pulverulent burnt clay materials for substituting fly ashes in geopolymer foam formulations.

There are presently two major application fields for geopolymer foams, i.e. thermal insulation and acoustic insulation (sound absorption). State of the art geopolymer foams comprise e.g. blast furnace slag, fly ash, and/or microsilica. These types of binders provide good workability of the resulting slurry, and the resulting foams show good mechanical strength. Mechanical strength is related to the reaction of the amorphous silica present in these binders with the alkaline activators used. However, most common waste materials (e.g. fly ash and blast furnace slag) contain high amounts of heavy metal ions (chromium, arsenic, selenium, molybdenum, and the like), which can be mobilized at high pH-values due to partial dissolution. Consequently, high amounts of heavy metal ions lead to a disposal problem for those geopolymers. Moreover, as coal-based power plants are likely phased out in Europe in the near future, the availability of fly ash is likely to diminish. On the other hand, blast furnace slag is in high demand and may not always be available in sufficient quantities.

Foam products are generally two-phase systems where one phase is gaseous and the other is solid or liquid. The gaseous phase here consists of fine gas bubbles delimited by solid or liquid cell walls. The cell walls meet one another at nodes and thus form a framework.

Foams with thermal insulation properties are mostly closed-cell foams. They should exhibit high air flow resistivity, low density and good mechanical properties. Foams with sound-absorbing properties are mostly open-cell foams. The thin partitions between the delimiting walls here are disrupted at least to some extent, and there is at least some connection between the cells. The materials thus act as porous absorbers.

Very many different materials are used for the cell walls in open- and closed-cell foams. They range from metals to inorganic materials to organic polymers. Organic polymer foams are divided, on the basis of their rigidity, into flexible and rigid foams. Formation of bubbles in these is mostly achieved by way of a blowing gas which is produced in situ via a chemical reaction, or by way of a chemical compound which is dissolved in the organic matrix and which, at low temperatures, boils or decomposes to give gaseous products. Foams can also be produced via mechanical mixing to incorporate gases, via polymerization in solution with phase separation, or via use of fillers which are dissolved away from the material after the curing process.

In the literature there are many descriptions of PUR foams. They are usually produced from isocyanate-containing compounds and polyols. Foaming predominantly uses blowing gases which have physical action by virtue of their low boiling point. There are also specific well-known blowing gas combinations of blowing gases having physical action and carbon dioxide produced via chemical reaction of the isocyanate groups with water during the foaming process. During reaction of water with isocyanates, unlike in the reaction of polyols, urea groups are produced alongside carbon dioxide, and contribute to the formation of the cell structure. Melamine foams provide another alternative.

A decisive disadvantage of organic polymer foams is that they are combustible, or, to use a different expression, have limited thermal stability. Even organic polymer foams classified as having “low flammability” can, on combustion, liberate toxic gases and produce flaming drops. They can also, if they have been produced in particular ways and have particular compositions, liberate fumes that are hazardous in indoor areas, an example being formaldehyde. There was therefore a requirement for incombustible inorganic foams.

DE 102004006563 A1 describes a process for the production of an inorganic-organic hybrid foam by the following steps: a) mixing of at least one inorganic reactive component that forms a stonelike material, at least one aqueous hardener which, under alkaline conditions, brings about a curing reaction of the at least one inorganic reactive component, at least one foaming agent, at least one organic silicon compound and at least one surfactant, and b) at least partial hardening of the mixture. However, no purely inorganic foam is formed here.

DE 4301749 A1 describes an acoustic damper for the passage of exhaust gases from internal combustion engines with at least one sound-absorbing body made of a porous material. In order to achieve the best possible acoustic damping together with simple production, it is proposed that the material is based on a geopolymer. However, the composition of the geopolymer here is not explained in any greater detail.

WO 2011/106815 A1 describes a formulation for the production of a fire-protection mineral foam comprising or consisting of a waterglass, at least one aluminum silicate, at least one hydroxide and at least one oxide component from a group comprising SiO₂ and Al₂O₃, characterized in that the waterglass is present in a proportion selected from a range of 10 parts by weight and 50 parts by weight, the aluminum silicate is present in a proportion such that the proportion of Al₂O₃ is from 8 parts by weight to 55 parts by weight, the hydroxide is present in a proportion such that the proportion of OH is from 0.5 part by weight to 4 parts by weight and the oxide component is present in a proportion of from 5 parts by weight to 55 parts by weight; it also describes the mineral foam and a process for the production of the mineral foam.

In our previous European patent EP 3063100 B1, we claim a geopolymer foam formulation comprising:
at least one inorganic binder which comprises blast furnace slag, and also comprises microsilica and/or metakaolin;
at least one alkaline activator selected from the group consisting of alkali metal hydroxides, alkali metal carbonates, alkali metal aluminates, alkali metal silicates and mixtures thereof;
at least one alkyl polyglucoside;
a gas phase and water.

In our previous European patent EP 3530631 B1, we claim a geopolymer foam formulation, comprising:
at least one inorganic binder which comprises metakaolin,
at least one alkaline activator, selected from the group consisting of alkali metal hydroxides, alkali metal carbonates, alkali metal aluminates, alkali metal silicates and mixtures thereof;
at least one nonionic surfactant, where the surfactant is an alkyl polyglucoside;
a gas phase and water.

This at least one inorganic binder (comprising metakaolin) can be selected from the group consisting of blast furnace slag, microsilica, metakaolin, aluminosilicates, fly ash and mixtures thereof.

However, as mentioned above, blast furnace slag and fly ash which are of advantage when it comes to compressive strength of the hardened foams and workability of the slurries, contain heavy metal pollutants which pose a disposal problem and should therefore be avoided (substituted), if possible without worsening the quality of the obtained geopolymer foams.

The object of the present invention therefore consisted in eliminating, at least to some extent, the prior-art disadvantages described in the introduction. In particular the intention was to provide a geopolymer foam formulation for the manufacture of a hardened geopolymer foam with adequate compressive strength. It was also an objective of the present invention to avoid (substitute) fly ash in geopolymer foam formulations.

Said object has been achieved with the features of the independent claims. The dependent claims provide preferred embodiments.

In order to solve the above-mentioned problem, alternative binders have been investigated and implemented in geopolymer foam formulations. It was found that pulverulent burnt clay materials (e.g. cutting waste from ceramic bricks or roof tiles, herein collectively called brick dust) can be used. Because of its chemical composition, ceramic waste is capable to co-react with the geopolymer binder. This reaction resulted in good mechanical strength comparable to foams comprising fly ash.

The present invention firstly provides a geopolymer foam formulation comprising an inorganic binder selected from metakaolin, microsilica and mixtures thereof; at least one pulverulent burnt clay material; at least one alkaline activator selected from the group consisting of alkali metal hydroxides, alkali metal carbonates, alkali metal aluminates, alkali metal silicates and mixtures thereof; at least one surfactant of the alkyl polyglucoside type; a gas phase and water.

For the purposes of the present invention, the expression “geopolymer foam formulation” is intended to mean that this formulation comprises all of the components required in order to provide a geopolymer foam, i.e. an inorganic binder, a pulverulent burnt clay material, an alkaline activator, a surfactant (i.e. an alkyl polyglucoside), water and a gas phase. These components can take the form of premix, or else can be in separate form as what is known as a “kit of parts”. As stated at a later stage below, the water and the alkaline activator can be provided separately from the solid components, or the alkaline activator can be in dry form together with the solid components, so that it is only necessary to add water and to carry out foaming. It is, of course, also possible that the geopolymer foam formulation is in ready-foamed form.

According to the invention, the “gas phase” can be the gas present in the powder components. This quantity of gas is often not in itself sufficient. It is therefore also possible that gas provided in a suitable form is involved here, for example gas in the form of gas bottles, compressed gas, compressed air, etc. For the purposes of the present invention, the expression gas phase is also intended to cover hydrogen gas liberated by way of a reaction with the alkaline aqueous medium deriving from metals such as Mg, Al, Zn, or oxygen gas produced in the alkaline medium from H₂O₂ or peroxides, or nitrogen gas produced from labile nitrogen-containing compounds, and also gas in the form of (optionally soluble or reactive) hollow microbeads. The expression “gas phase” can therefore also be understood as synonymous with “a component comprising or liberating a gas phase”. If the geopolymer foam formulation is already foamed, the expression “gas phase” means, of course, that gas bubbles are present in the foam matrix. The regions occupied by the gas bubbles in the hardened “geopolymer foam” are also sometimes termed air pores.

For the purposes of the present invention, the term “comprising” is intended to include the narrower term “consisting of”, but not to be synonymous therewith. It is moreover intended that in each actual case the sum of all of the percentages of the specified and unspecified constituents of the formulation of the invention is always 100%.

It is well known that inorganic binder systems can be based on reactive water-insoluble compounds based on SiO₂ in conjunction with Al₂O₃ which harden in an aqueous alkaline environment. Binder systems of this type are termed inter alia “geopolymers”, and are described by way of example in U.S. Pat. No. 4,349,386, WO 85/03699 and U.S. Pat. No. 4,472,199. Materials that can be used as reactive oxide or reactive oxide mixture here are inter alia microsilica, metakaolin, aluminosilicates, fly ash, activated clay, pozzolanes or a mixture thereof. The alkaline environment used to activate the binders usually consists of aqueous solutions of alkali metal carbonates, alkali metal fluorides, alkali metal hydroxides, alkali metal aluminates and/or alkali metal silicates, e.g. soluble waterglass. Geopolymers can be less costly and more robust than Portland cement and can have a more advantageous CO₂ emission balance.

Pure geopolymers generally have low calcium content, because they use the abovementioned oxides. Our U.S. Pat. No. 8,460,459 B2 describes an inorganic binder system which comprises from 12 to 25% by weight of CaO, and which permits production of construction chemistry products that are resistant to chemical attack.

For the purposes of the present invention, a “latently hydraulic binder” is preferably a binder in which the molar ratio (CaO+MgO):SiO₂ is from 0.8 to 2.5 and particularly from 1.0 to 2.0. In general terms, the abovementioned latently hydraulic binders can be selected from industrial and/or synthetic slag, in particular from blast furnace slag, electrothermal phosphorous slag, steel slag and mixtures thereof.

The “pozzolanic binders” can generally be selected from amorphous silica, preferably precipitated silica, fumed silica and microsilica, ground glass, metakaolin, aluminosilicates, fly ash, preferably brown-coal fly ash and hard-coal fly ash, natural pozzolanes such as tuff, trass and volcanic ash, natural and synthetic zeolites and mixtures thereof.

Of course, as mentioned at an earlier stage, blast furnace slag (and other slags) as well as fly ash should be avoided for the purpose of the present invention. If, in some cases, blast furnace slag cannot be avoided, at least fly ash should be avoided.

Blast furnace slag (BFS) is a waste product of the glass furnace process. Other materials are granulated blast furnace slag (GBFS) and ground granulated blast furnace slag (GGBFS), which is granulated blast furnace slag that has been finely pulverized. Ground granulated blast furnace slag varies in terms of grinding fineness and grain size distribution, which depend on origin and treatment method, and grinding fineness influences reactivity here. The Blaine value is used as parameter for grinding fineness, and typically has an order of magnitude of from 200 to 1000 m² kg⁻¹, preferably from 300 to 500 m² kg⁻¹. Finer milling gives higher reactivity.

Amorphous silica is preferably an X-ray-amorphous silica, i.e. a silica for which the powder diffraction method reveals no crystallinity. The content of SiO₂ in the amorphous silica of the invention is advantageously at least 80% by weight, preferably at least 90% by weight. Precipitated silica is obtained on an industrial scale by way of precipitating processes starting from waterglass. Precipitated silica from some production processes is also called silica gel.

Fumed silica is produced via reaction of chlorosilanes, for example silicon tetrachloride, in a hydrogen/oxygen flame. Fumed silica is an amorphous SiO₂ powder of particle diameter from 5 to 50 nm with specific surface area of from 50 to 600 m² g⁻¹.

Microsilica is a by-product inter alia of silicon production or ferrosilicon production, and likewise consists mostly of amorphous SiO₂ powder. The particles have diameters of the order of magnitude of 0.1 μm. Specific surface area is of the order of magnitude of from 15 to 30 m² g⁻¹.

In contrast to this, commercially available quartz sand is crystalline and has comparatively large particles and comparatively small specific surface area. It serves as inert filler in the invention.

Fly ash is produced inter alia during the combustion of coal in power stations. Class C fly ash (brown-coal fly ash) comprises according to WO 08/012438 about 10% by weight of CaO, whereas class F fly ash (hard-coal fly ash) comprises less than 8% by weight, preferably less than 4% by weight, and typically about 2% by weight of CaO.

Metakaolin is produced when kaolin is dehydrated. Whereas at from 100 to 200° C., kaolin releases physically bound water, at from 500 to 800° C., a dehydroxylation takes place with collapse of the lattice structure and formation of metakaolin (Al₂Si₂O₇). Accordingly, pure metakaolin comprises about 54% by weight of SiO₂ and about 46% by weight of Al₂O₃.

An overview of raw materials for geopolymers is found by way of example in Caijun Shi, Pavel V. Krivenko, Della Roy, Alkali-Activated Cements and Concretes, Taylor & Francis, London & New York, 2006, pp. 6-63.

According to one preferred embodiment of the formulation of the invention, the inorganic binder comprises metakaolin, microsilica and mixtures thereof. A mixture of metakaolin and microsilica is particularly preferred. Metakaolin and/or microsilica should preferably amount to about 5 to 50% by weight of the geopolymer foam formulation of the invention.

The burnt clay material according to the present invention should be present in powder form in order to ensure its full reactivity, i.e. as a “pulverulent burnt clay material”.

The term “clay” as used throughout this specification is a mixture of varying amounts of kaolinite, montmorillonite, smectite and illite. However, clay may not entirely consist of kaolinite because the corresponding burnt clay material would then be a porcelain.

The pulverulent burnt clay material is a ceramic as used in construction industry, such as in bricks and roof tiles. More particularly it is “brick dust” (syn. “brick waste”). The pulverulent burnt clay material is made from crushed or cut bricks or roof tiles, i.e. a waste material incurred in the production of these products. Chemically, the material is ground and calcinated clay with few pozzolanic components. The firing temperature is usually between 900 and 1100° C. The following chemical composition of a typical milled ceramic waste material (“Ziegelmehl”) was measured via XRF (Table 1).

TABLE 1

| | Milled brick waste |
|---|---|
| Solid state chemistry | (“Ziegelmehl”, PILOSITH |
| (XRF, fused bead): | GmbH, Parensen, Germany) |
| Sulfate SO₃ [wt.-%] | 0.08 |
| Calcium CaO [wt.-%] | 0.75 |
| Potassium K₂O [wt.-%] | 3.26 |
| Sodium Na₂O [wt.-%] | 0.93 |
| Silicon SiO₂ [wt.-%] | 65.05 |
| Iron Fe₂O₃ [wt.-%] | 5.81 |
| Aluminum Al₂O₃ [wt.-%] | 16.29 |
| Magnesium MgO [wt.-%] | 1.50 |

Upon measurement of different types of ceramic materials, it can be said that the pulverulent burnt clay should comprise from 30 to 75% by weight of SiO₂, preferably from 40 to 70%, and from 5 to 35% of Al₂O₃, preferably from 10 to 25%.

The pulverulent burnt clay material should preferably amount to about 5 to 50% by weight of the geopolymer foam formulation of the invention.

If, as a preferred embodiment, a low density of the hardened foams for thermal insulation applications is required (about 50-350 g/L) it can be necessary to mill the pulverulent burnt clay materials to a d₉₀-value below 1350 μm and a do-value below 600 μm, preferably a d₉₀-value below 400 μm and a d₅₀-value below 150 μm, and in particular a doo-value below 100 μm and a d₅₀-value below 30 μm, as measured by laser granulometry.

It is preferable to use an alkaline activator selected from alkali metal hydroxides of the formula MOH and alkali metal silicates of the formula m SiO₂·n M₂O, wherein M stands for Li, Na or K, or a mixture thereof, and the molar ratio m:n is ≤4.0, preferably ≤3.0, more preferably ≤2.0 and in particular ≤1.7.

The alkali metal silicate is preferably waterglass, particularly preferably an aqueous waterglass and in particular a sodium waterglass or potassium waterglass. However, it is also possible to use lithium waterglass or ammonium waterglass or a mixture of the waterglasses mentioned.

The min ratio stated above (also termed “modulus”) should preferably not be exceeded, since otherwise reaction of the components is likely to be incomplete. It is also possible to use much smaller moduli, for example about 0.2. Waterglasses with higher moduli should be adjusted before use to moduli in the range of the invention by using a suitable aqueous alkali metal hydroxide.

Potassium waterglasses in the advantageous modulus range are mainly marketed as aqueous solutions because they are very hygroscopic; sodium waterglasses in the advantageous modulus range are also obtainable as solids. The solids contents of the aqueous waterglass solutions are generally from 20% by weight to 60% by weight, preferably from 30 to 50% by weight.

Waterglasses can be produced industrially via melting of quartz sand with the appropriate alkali metal carbonates. However, they can also be obtained without difficulty from mixtures of reactive silica with the appropriate aqueous alkali metal hydroxides. It is therefore possible in the invention to replace at least some of the alkali metal silicate with a mixture of a reactive silica and of the appropriate alkali metal hydroxide.

In one preferred embodiment of the present invention, the alkaline activator therefore comprises a mixture of alkali metal hydroxide(s) and alkali metal silicate(s).

The preferred quantity of the alkaline activator in the invention, based on the geopolymer foam formulation (including water), is from 1 to 55% by weight and in particular from 20 to 50% by weight, where these percentages relate to the solid contents of the activator.

The surfactant mentioned above is an essential constituent of the geopolymer foam formulation of the invention. Only the simultaneous presence of surfactant and water permits stabilization, in this geopolymer foam formulation, of a gas phase in the form of gas bubbles which are responsible for the pore structure in the hardened geopolymer foam and, respectively, in the geopolymer foam element described at a later stage below.

Not all surfactants are equally effective in the highly alkaline geopolymer foam formulation comprising waterglass, pozzolanic binders and pulverulent burnt clay materials. It has been found that preferably alkyl polyglucosides have the best suitability for stabilizing the gas phase and therefore the foam.

A typical alkyl polyglucoside has the formula H—(C₆H₁₀O₅)ₘ—O—R′, where (C₆H₁₀O₅) is a glucose unit, R′ is a C₆₋₂₂-alkyl group, preferably a C₆₋₁₈-alkyl group and more preferably a C₆₋₁₂-alkyl group, and m is from about 1 to 5. Mixtures of two, three or more alkyl polyglucosides with different alkyl groups are also comprised by the present invention.

The proportion of the surfactant, based on the geopolymer foam formulation of the invention, can advantageously be from 0.01 to 5% by weight, preferably from 0.1 to 2% by weight and in particular from 0.2 to 1.5% by weight.

The abovementioned gas phase is advantageously selected from the group consisting of air, oxygen, hydrogen, nitrogen, a noble gas, hydrocarbons and mixtures thereof. It can be introduced into the formulation via chemical processes (for example decomposition of H₂O₂ or of other peroxides or of nitrogen-containing compounds or by reaction of metals with the alkaline activator), or via mechanical foaming.

In one preferred embodiment of the present invention, the gas phase makes up from 20 to 90 percent by volume, in particular from 50 to 80 percent by volume, of the geopolymer foam formulation and consequently of the hardened geopolymer foam.

The formulation of the invention is moreover characterized in that it advantageously comprises from 10 to 60% by weight, preferably from 10 to 50% by weight, and in particular from 20 to 50% by weight of water.

Expressed differently, the ratio by weight of water to binder (w/b-value), where the solids content of the alkaline activator must be counted with the binder and the pulverulent burnt clay material, and the water content of the alkaline activator must be counted with the water, is from 0.10 to 1.5, in particular from 0.33 to 1.0.

The solidification behavior or the setting time of the geopolymer foam formulation of the invention can be influenced advantageously by adding cement. A particularly suitable material here is Portland cement, calcium aluminate cement, calcium sulfoaluminate cement, or a mixture thereof. It is also possible to use composite cements. Cements are well known in the prior art (cf. DIN EN 197).

The amount of cement should suitably be up to 20% by weight, preferably less than 10% by weight and in particular less than 5% by weight. It is preferable that the proportion of the cement in the geopolymer foam formulation is at least 1% by weight, preferably at least 2% by weight and in particular at least 3% by weight. The setting time can be controlled by adding Ca(OH)₂ or CaO-containing components (such as cement). The proportion of CaO, based on a water-free geopolymer foam formulation, can be from 10 to 25% by weight, in particular from 15 to 20% by weight.

As mentioned above, all constituents of formulation according to the invention can be present together as a single component, or the solid constituents may be held in a first, solid component and the water is held in a second, liquid component, or the at least one inorganic binder and the at least one pulverulent burnt clay material are held together in a first, solid component and the at least one alkaline activator and the water are held in a second, liquid component.

Many other additives can be present in the geopolymer foam formulation of the invention. The formulation can also comprise at least one additive for foam stabilization, shrinkage reduction, flexibilization, hydrophobization, or dispersion, fibers and fillers or a mixture thereof.

For dispersion it is possible to use additives from the group consisting of naphthalenesulfonate, lignosulfonate, comb polymers such as polycarboxylate ethers, comb-shaped polyaromatic ethers, comb-shaped cationic copolymers and mixtures thereof. Dispersing agents of this type are well known in the prior art. Comb-shaped polyaromatic ethers which have particularly good suitability for increasing flowability of silicate-containing geopolymer systems are described by way of example in our WO 2013/152963 A1. Comb-shaped cationic copolymers which have particularly good suitability for increasing flowability of highly alkaline geopolymer systems are described by way of example in our WO 2015/043805 A1.

The entire geopolymer foam formulation of the invention can comprise:
from 5 to 50% by weight of metakaolin and/or microsilica, preferably from 10 to 30%,
from 5 to 50% by weight of pulverulent burnt clay materials, preferably from 10 to 30%,
from 1 to 55% by weight of alkaline activator (calculated as solids), preferably from 5 to 30%,
from 10 to 50% by weight of water (total quantity), preferably from 15 to 35%,
from 0.01 to 5% by weight of surfactant, preferably from 0.1 to 1.5% and a gas phase.

The present invention secondly provides a process for the manufacture of the formulation of the invention comprising the steps of mixing the solid and liquid components of the formulation and introducing the gas phase by means of mechanical and/or chemical foaming.

Thirdly, the present invention provides a process for the manufacture of a hardened geopolymer foam, comprising the steps of mixing the solid and liquid components of the formulation, introducing the gas phase by means of mechanical and/or chemical foaming and allowing the formulation to harden. Expressed differently, the hardened geopolymer foam is obtainable from the geopolymer foam formulation by hardening (and optional drying).

The density of the hardened geopolymer foam, dried to a residual water content of about 5% by weight, is preferably (i.e. the “dry apparent density”) from 50 to 350 kg/m³, particularly preferably from 100 to 300 kg/m³.

Furthermore, the present invention provides a geopolymer foam element comprising that hardened geopolymer foam of the invention.

Finally, the present invention provides the use of pulverulent burnt clay materials for substituting fly ashes in geopolymer foam formulations.

The examples and the attached figures below will now provide further, non-limiting explanation of the present invention. In the drawings:

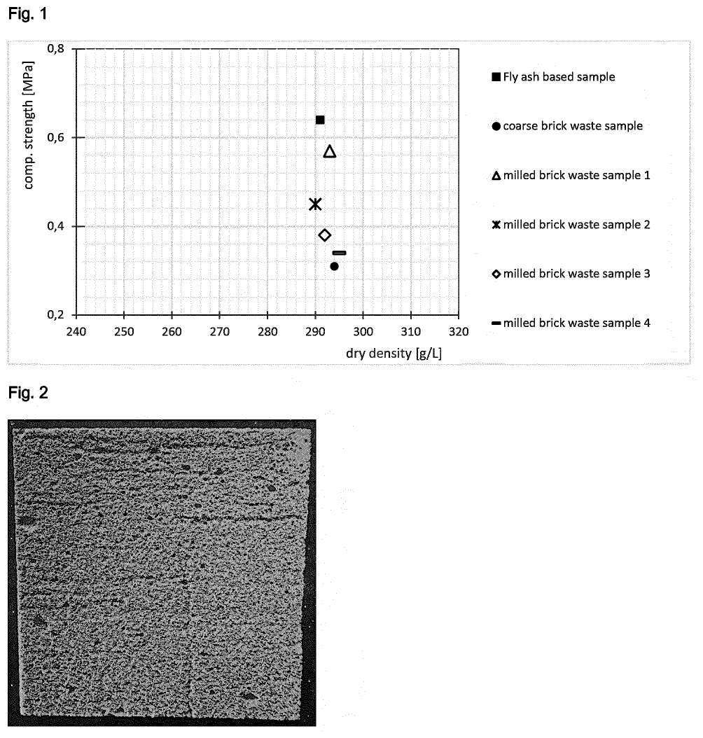

FIG. 1 shows a comparison of compressive strengths of different geopolymer foam samples,

FIG. 2 shows a hardened geopolymer foam containing metakaolin and fly ash,

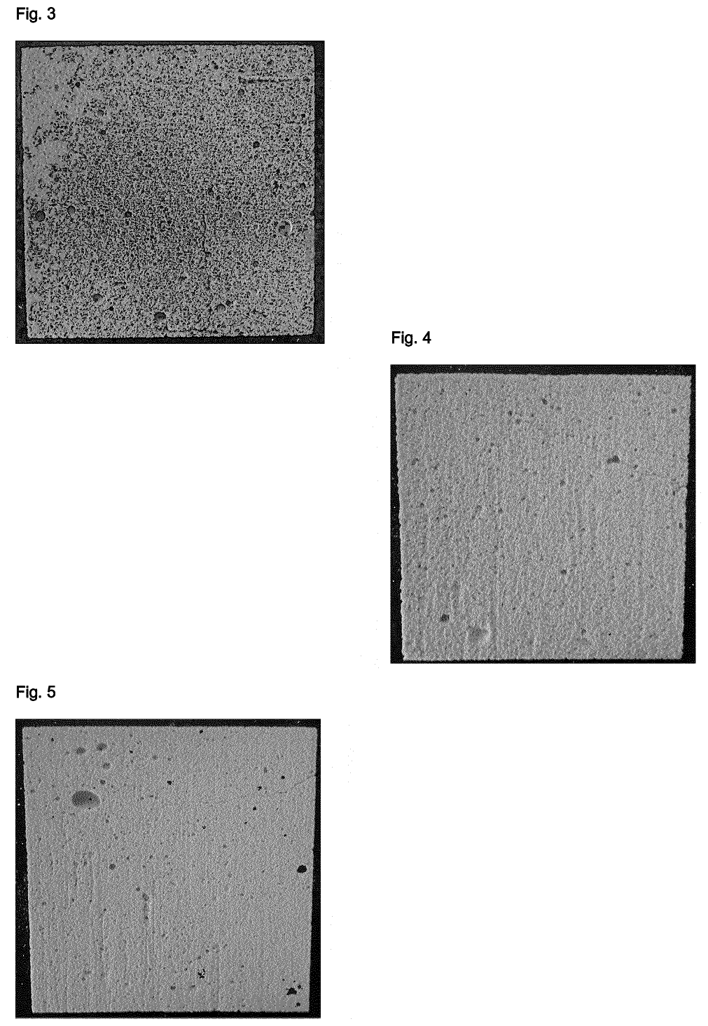

FIG. 3 shows a hardened geopolymer foam containing metakaolin, fly ash and microsilica,

FIG. 4 shows a hardened geopolymer foam containing metakaolin and slag,

FIG. 5 shows a hardened geopolymer foam containing metakaolin, slag and microsilica,

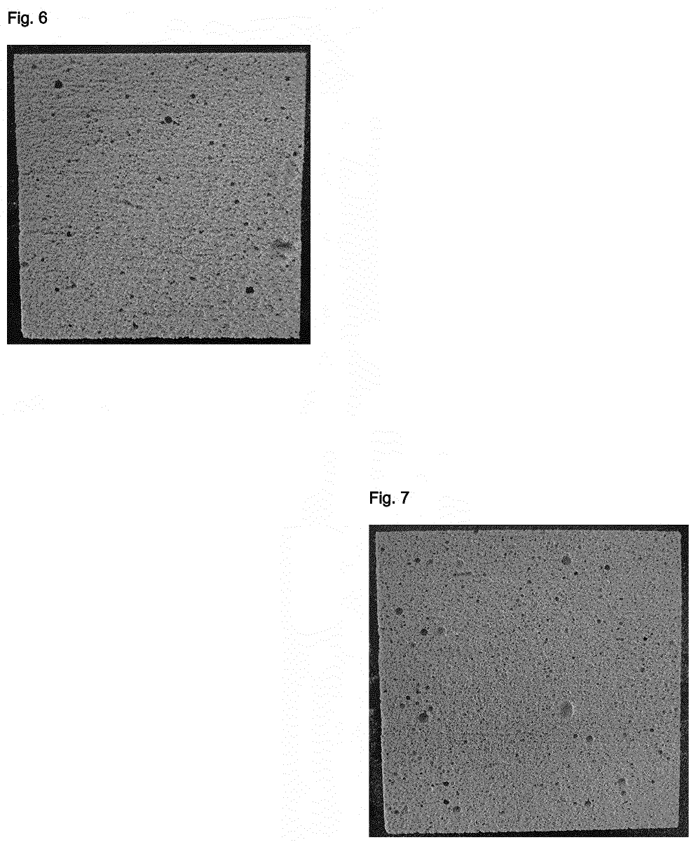

FIG. 6 shows a hardened geopolymer foam containing metakaolin and milled brick waste, and

FIG. 7 shows a hardened geopolymer foam containing metakaolin, milled brick waste and microsilica.

### EXAMPLES

### Characterization of the Starting Materials:

An eluate analysis of constituents of geopolymer foam formulations, performed according to DIN EN ISO 11885 (E 22): 2009-09, can be found in Table 2 hereinbelow. Fly ash, for instance, contains high amounts Barium, Chromium, Molybdenum and Selenium. Microsilica, on the other hand, contains high amounts of Arsenic. Upon use, the contamination with heavy metals is transferred to the resulting geopolymers leading to a disposal problem of the geopolymer material.

TABLE 2

| | | | Microsilica | Ceramic |
|---|---|---|---|---|
| | Fly ash | Slag | (RW-Fuller | brick waste |
| | (Microsit 10, | (Karlstatt | Q1+, RW | (Ziegelmehl, |
| | BauMineral | 4000, | silicium | PILOSITH |
| | GmbH, | Schwenk | GmbH, | GmbH, |
| Eluate | Herten, | Zement KG, | Pocking, | Parensen, |
| Analysis | DE) | Ulm, DE) | DE) | DE) |
| As [mg/L] | 0.04 | 0.001 | 0.29 | 0.07 |
| Ba [mg/L] | 0.49 | 0.05 | <0.01 | 0.04 |
| Cl [mg/L] | 10.92 | 13.12 | 12.22 | 10.40 |
| Cr [mg/L] | 0.39 | 0.02 | 0.01 | 0.01 |
| Cu [mg/L] | <0.001 | <0.001 | 0.01 | 0.01 |
| Mo [mg/L] | 1.21 | 0.01 | 0.02 | 0.03 |
| S [mg/L] | 292.8 | 22.8 | 9.98 | 26.6 |
| Sb [mg/L] | 0.03 | <0.0001 | <0.0001 | <0.0001 |
| Se [mg/L] | 0.14 | 0.004 | <0.001 | <0.001 |

Ceramic brick waste thus comprises low amounts of elutable pollutants. Milling of the brick waste is advantageous in order to obtain high-strength low-density foams, as shown in FIG. 1 hereinbelow.

The chemical composition of the above-mentioned milled ceramic brick waste (“Ziegelmehl”) was already reported in Table 1 above. The chemical compositions of other silica-based starting materials (the same types as mentioned above) were measured via XRF (see Table 3 hereinbelow):

TABLE 3

| Solid state chemistry | | | |
|---|---|---|---|
| (XRF, fused bead) | Fly ash | Slag | Microsilica |
| Sulfate SO₃ [wt.-%] | 0.55 | 0.86 | 0.02 |
| Calcium CaO [wt.-%] | 4.64 | 41.82 | 0.06 |
| Potassium K₂O [wt.-%] | 2.30 | 0.54 | 0.05 |
| Sodium Na₂O [wt.-%] | 1.10 | 0.22 | <0.01 |
| Silicon SiO₂ [wt.-%] | 51.87 | 36.28 | 95.21 |
| Iron Fe₂O₃ [wt.-%] | 6.44 | 0.54 | 0.20 |
| Aluminum Al₂O₃ [wt.-%] | 23.57 | 11.45 | 0.15 |
| Magnesium MgO [wt.-%] | 2.18 | 6.79 | <0.01 |

Beside the chemical composition of the constituents, their particle size is very important. A low particle size and advantageous grain size distribution are beneficial to achieve robust foams at low densities (<200 g/L). Lowering the density of a foamed material also induces a lowering of the thickness of the cellular walls. This requires the aggregate size of the fillers being significantly smaller than the average cell wall thickness of the resulting inorganic foam. The particle size distributions are reported in Table 4 hereinbelow. Particle sizes were determined by laser granulometry (“MasterSizer 2000”, Malvern Panalytical, UK).

TABLE 4

| | | | Slag | Microsilica |
|---|---|---|---|---|
| | Fly ash | Fly ash | (Karlstatt | (RW-Fuller |
| | (Microsit 10, | (Microsit 90, | 4000, | Q1+, RW |
| | BauMineral | BauMineral | Schwenk | silicium |
| | GmbH, | GmbH, | Zement | GmbH, |
| Particle-size | Herten, | Herten, | KG Ulm, | Pocking, |
| Distribution | DE) | DE) | DE) | DE) |
| d₁₀ [μm] | 0.8 | 2.1 | 1.5 | 1.1 |
| d₅₀ [μm] | 3.9 | 14.2 | 10.1 | 2.5 |
| d₆₃ [μm] | 5.1 | 22.2 | 14.8 | 3.4 |
| d₉₀ [μm] | 10.2 | 63.8 | 35.6 | 12.7 |

For brick waste “Ziegelmehl 0-1.25 mm” (obtained from PILOSITH GmbH, Parensen, Germany), particle size distribution was determined. Milling was performed at 70 rpm for 50 minutes (sample 1), 35 minutes (sample 2), 25 minutes (sample 3) or 15 minutes (sample 4) in a Retsch BT100XL ball mill (RETSCH GmbH, Haan, Germany). Particle size distribution of the brick waste “as received” and the milled brick waste samples is presented in Table 5. (This particle size distribution is very similar to Microsit 90 fly ash—see Table 4 above). The particle size measurement was performed by means of laser granulometry (“MasterSizer 2000”, Malvern Panalytical, UK).

TABLE 5

| | Brick | Milled | Milled | Milled | Milled |
|---|---|---|---|---|---|
| | waste | brick | brick | brick | brick |
| Particle-size | “as | waste | waste | waste | waste |
| distribution | received” | sample1 | sample 2 | sample 3 | sample 4 |
| d₁₀ [μm] | 48 | 2.3 | 9.2 | 15.7 | 28.3 |
| d₅₀ [μm] | 574 | 16.6 | 111.7 | 225.2 | 406.5 |
| d₆₃ [μm] | 763 | 25.5 | 172.3 | 335.8 | 571.7 |
| d₉₀ [μm] | 1306 | 60.9 | 351.4 | 650.7 | 1087.8 |

### Example 1

To illustrate the influence of particle sizes on compressive strength of hardened geopolymer foams, samples were prepared from the following composition of raw materials in percent by weight.
31.6% Potassium Waterglass (“Kaliumwasserglas 58”, BASF SE, Ludwigshafen, Germany 56% in H₂O, module=1.7)
3.2% Sodium Waterglass (“Metso 520”, PQ Corp., Amersfoort, Netherlands, module=1.0) 19.4% Water
0.7% C₈₋₁₀-Alkypolyglucoside (“Glucopon 225 DK”, BASF SE, Ludwigshafen, Germany)
22.0% Metakaolin (“Argical M 1200S”, Imerys Refractory Minerals, Clérac, France, d₅₀=1-2 μm)
2.7% Acrylic Dispersion (“Acronal S430P”, BASF SE, Ludwigshafen, Germany)
20.4% component a, b, c, d, e or f
a) Fly Ash Class F (“Microsit 10”)
b) Coarse brick waste “as received” (“Ziegelmehl 0-1.25 mm”)
c) Milled brick waste sample 1 (“Ziegelmehl 0-1.25 mm”) according to Table 5.
d) Milled brick waste sample 2 (“Ziegelmehl 0-1.25 mm”) according to Table 5.
e) Milled brick waste sample 3 (“Ziegelmehl 0-1.25 mm”) according to Table 5.
f) Milled brick waste sample 4 (“Ziegelmehl 0-1.25 mm”) according to Table 5.

Foam samples containing component a, b, c, d, e or f, respectively, were produced by mixing the liquid raw materials. The solid raw materials were added to the liquid components and stirred until a homogeneous slurry was created. The foam was then generated with a kitchen mixer. The so obtained foam was poured into a mold. The setting reaction took place and the foam started to solidify. The geopolymer foam was stored in humid atmosphere for 3 days to allow proper setting. Thereafter, it was demolded and dried at RT until constant mass. The resulting geopolymer foam samples exhibited a dimension of 300 mm×300 mm×40 mm respectively. The following properties were measured for the foam samples:
a) Dry density: 291 kg/m³
   Compressive strength after ≥28d: 0.64 MPa
b) Dry density: 294 kg/m³
   Compressive strength after ≥28d: 0.31 MPa
c) Dry density: 293 kg/m³
   Compressive strength after ≥28d: 0.57 MPa
d) Dry density: 290 kg/m³
   Compressive strength after ≥28d: 0.45 MPa
e) Dry density: 292 kg/m³
   Compressive strength after ≥28d: 0.38 MPa
f) Dry density: 295 kg/m³
   Compressive strength after ≥28d: 0.34 MPa

The results are illustrated in FIG. 1 (dry density vs. compressive strength). The results using brick waste “as received” were satisfactory considering that no fly ash was used. But the finer the brick waste was milled, the higher the compressive strength values were at a dry density comparable to the fly ash sample.

### Example 2 (Comparative)

A geopolymer foam was prepared from the following composition of raw materials in weight percent.
37.0% Potassium Waterglass (“Kaliumsilikat K 45 M”, Woellner GmbH, Ludwigshafen, DE,
40% in H₂O, module=1.0)
21.2% Sodium Hydroxide solution (10% in H₂O)
0.45% C₁₀₋₁₆-Alkypolyglucoside (“Glucopon GD 70”, BASF SE)
0.15% C₈₋₁₀-Alkypolyglucoside (“Glucopon 225 DK”, BASF SE)
26.3% Metakaolin (“Argical M 1200S”, Imerys Refractory Minerals, Clérac, FR, d₅₀=1-2 μm)
14.9% Fly Ash Class F (“Microsit 90”, BauMineral GmbH, Herten, DE, about 5% CaO, 4.400 cm²/g)

The liquid raw materials were first mixed with NaOH solution. The solid raw materials were then added to the liquid components and stirred until a homogeneous slurry was created. The foam was then generated with a kitchen mixer. The so obtained foam had a wet density of 190 kg/m³ and was poured into a mold. The setting reaction took place and the foam started to solidify. The geopolymer foam was stored in humid atmosphere for 3 days to allow proper setting. Thereafter, it was demolded and dried at RT until constant mass.

The resulting geopolymer foam element exhibited a dimension of 300 mm×300 mm×40 mm. A few cracks were visible in the sample (FIG. 2). The following properties were measured:
Dry density: 121 kg/m³
Compressive strength after ≥28d: 31 kPa
Thermal conductivity: 38.7 mW/m·K

### Example 3 (Comparative)

A geopolymer foam was prepared from the following composition of raw materials in weight percent:
37.0% Potassium Waterglass (“Kaliumsilikat K 45 M”, Woellner GmbH, Ludwigshafen, DE, 40% in H₂O, module=1.0)
21.2% Sodium Hydroxide solution (10% in H₂O)
0.45% C₁₀₋₁₆-Alkypolyglucoside (“Glucopon GD 70”, BASF SE)
0.15% C₈₋₁₀-Alkypolyglucoside (“Glucopon 225 DK”, BASF SE)
21.3% Metakaolin (“Argical M 1200S”, Imerys Refractory Minerals, Clérac, FR, d₅₀=1-2 μm)
14.9% Fly Ash Class F (“Microsit 90”, BauMineral GmbH, Herten, DE, about 5% CaO, 4.400 cm²/g)
5.0% Microsilica (“RW-Füller Q1+”, RW silicium GmbH, Pocking, DE, 330-360 kg/m³)

The liquid raw materials were first mixed with NaOH solution. The solid raw materials were added to the liquid components and stirred until a homogeneous slurry was created. The foam was then generated with a kitchen mixer. The so obtained foam had a wet density of 197 kg/m³ and was poured into a mold. The setting reaction took place and the foam started to solidify. The geopolymer foam was stored in humid atmosphere for 3 days to allow proper setting. Thereafter, it was demolded and dried at RT until constant mass.

The resulting geopolymer foam element exhibited a dimension of 300 mm×300 mm×40 mm. Very few cracks were visible in the sample (FIG. 3). The following properties were measured:
Dry density: 132 kg/m³
Compressive strength after ≥28d: 91 kPa
Thermal conductivity: 42.0 mW/m·K

### Example 4 (Comparative)

A geopolymer foam was prepared from the following composition of raw materials in weight percent:
37.0% Potassium Waterglass (“Kaliumsilikat K 45 M”, Woellner GmbH, Ludwigshafen, DE, 40% in H₂O, module=1.0)
21.2% Sodium Hydroxide solution (10% in H₂O)
0.45% C₁₀₋₁₆-Alkypolyglucoside (“Glucopon GD 70”, BASF SE)
0.15% C₈₋₁₀-Alkypolyglucoside (“Glucopon 225 DK”, BASF SE)
26.3% Metakaolin (“Argical M 1200S”, Imerys Refractory Minerals, Clérac, FR,d₅₀=1-2 μm)
14.9% Slag (“Karlstatt 4000”, Schwenk Zement KG, Ulm, DE)

The liquid raw materials were first mixed with NaOH solution. The solid raw materials were added to the liquid components and stirred until a homogeneous slurry was created. The foam was then generated with a kitchen mixer. The so obtained foam had a wet density of 191 kg/m³ and was poured into a mold. The setting reaction took place and the foam started to solidify. The geopolymer foam was stored in humid atmosphere for 3 days to allow proper setting. Thereafter, it was demolded and dried at RT until constant mass.

The resulting geopolymer foam element exhibited a dimension of 300 mm×300 mm×40 mm. A few cracks were visible in the sample (FIG. 4). The following properties were measured:
Dry density: 137 kg/m³
Compressive strength after ≥28d: 42 kPa
Thermal conductivity: 38.3 mW/m·K

### Example 5 (Comparative)

A geopolymer foam was prepared from the following composition of raw materials in weight percent:
37.0% Potassium Waterglass (“Kaliumsilikat K 45 M”, Woellner GmbH, Ludwigshafen, DE, 40% in H₂O, module=1.0)
21.2% Sodium Hydroxide solution (10% in H₂O)
0.45% C₁₀₋₁₆-Alkypolyglucoside (“Glucopon GD 70”, BASF SE)
0.15% C₈₋₁₀-Alkypolyglucoside (“Glucopon 225 DK”, BASF SE)
21.3% Metakaolin (“Argical M 1200S”, Imerys Refractory Minerals, Clérac, FR, d₅₀=1-2 μm)
14.9% Slag (“Karlstatt 4000”, Schwenk Zement KG, Ulm, DE)
5.0% Microsilica (“RW-Füller Q1+”, RW silicium GmbH, Pocking, DE, 330-360 kg/m³)

The liquid raw materials were first mixed with NaOH solution. The solid raw materials were added to the liquid components and stirred until a homogeneous slurry was created. The foam was then generated with a kitchen mixer. The so obtained foam had a wet density of 197 kg/m³ and was poured into a mold. The setting reaction took place and the foam started to solidify. The geopolymer foam was stored in humid atmosphere for 3 days to allow proper setting. Thereafter, it was demolded and dried at RT until constant mass.

The resulting geopolymer foam part exhibited a dimension of 300 mm×300 mm×40 mm. A few cracks were visible in the sample (FIG. 5). The following properties were measured:
Dry density: 145 kg/m³
Compressive strength after ≥28d: 147 kPa
Thermal conductivity: 40.5 mW/m·K

### Example 6 (Inventive)

A geopolymer foam was prepared from the following composition of raw materials in weight percent:
37.0% Potassium Waterglass (“Kaliumsilikat K 45 M”, Woellner GmbH, Ludwigshafen, DE, 40% in H₂O, module=1.0)
21.2% Sodium Hydroxide solution (10% in H₂O)
0.45% C₁₀₋₁₆-Alkypolyglucoside (“Glucopon GD 70”, BASF SE)
0.15% C₈₋₁₀-Alkypolyglucoside (“Glucopon 225 DK”, BASF SE)
26.3% Metakaolin (“Argical M 1200S”, Imerys Refractory Minerals, Clérac, FR, d₅₀=1-2 μm)
14.9% Milled brick waste sample 1 (milled “Ziegelmehl 0-1.25 mm”, as mentioned in Table 5 above)

The liquid raw materials were first mixed with NaOH solution. The solid raw materials were added to the liquid components and stirred until a homogeneous slurry was created. The foam was then generated with a kitchen mixer. The so obtained foam had a wet density of 198 kg/m³ and was poured into a mold. The setting reaction took place and the foam started to solidify. The geopolymer foam was stored in humid atmosphere for 3 days to allow proper setting. Thereafter, it was demolded and dried at RT until constant mass.

The resulting geopolymer foam part exhibited a dimension of 300 mm×300 mm×40 mm. No cracks were visible in the sample (FIG. 6). The following properties were measured:
Dry density: 128 kg/m³
Compressive strength after ≥28d: 32 kPa
Thermal conductivity: 38.3 mW/m·K

### Example 7 (Inventive)

A geopolymer foam was prepared from the following composition of raw materials in weight percent:
37.0% Potassium Waterglass (“Kaliumsilikat K 45 M”, Woellner GmbH, Ludwigshafen, DE, 40% in H₂O, module=1.0)
21.2% Sodium Hydroxide solution (10% in H₂O)
0.45% C₁₀₋₁₆-Alkypolyglucoside (“Glucopon GD 70”, BASF SE)
0.15% C₈₋₁₀-Alkypolyglucoside (“Glucopon 225 DK”, BASF SE)
21.3% Metakaolin (“Argical M 1200S”, Imerys Refractory Minerals, Clérac, FR, d₅₀=1-2 μm)
14.9% Milled brick waste sample 1 (milled “Ziegelmehl 0-1.25 mm”, as mentioned in Table 5 above)
5.0% Microsilica (“RW-Füller Q1+”, RW silicium GmbH, Pocking, DE, 330-360 kg/m³)

The liquid raw materials were first mixed with NaOH solution. The solid raw materials were added to the liquid components and stirred until a homogeneous slurry was created. The foam was then generated with a kitchen mixer. The so obtained foam had a wet density of 191 kg/m³ and was poured into a mold. The setting reaction took place and the foam started to solidify. The geopolymer foam was stored in humid atmosphere for 3 days to allow proper setting. Thereafter, it was demolded and dried at RT until constant mass.

The resulting geopolymer foam part exhibited a dimension of 300 mm×300 mm×40 mm. No cracks were visible in the sample (FIG. 7). The following properties were measured:
Dry density: 124 kg/m³
Compressive strength after ≥28d: 93 kPa
Thermal conductivity: 40.2 mW/m·K

A summary of the results obtained in Examples 2-7 is presented in Table 6 below.

TABLE 6

| Components | Ex. 2 | Ex. 3 | Ex. 4 | Ex. 5 | Ex. 6 | Ex. 7 |
|---|---|---|---|---|---|---|
| Metakaolin | 63.8% | 51.7% | 63.8% | 51.7% | 63.8% | 51.7% |
| Fly ash | 36.2% | 36.2% | | | | |
| Slag | | | 36.2% | 36.2% | | |
| Milled brick | | | | | 36.2% | 36.2% |
| waste | | | | | | |
| Microsilica | | 12.1% | | 12.1% | | 12.1% |
| Comments | cracks | Small | cracks | Small | No | No |
| | | cracks | | cracks | cracks | cracks |
| Wet density | 190 | 197 | 191 | 197 | 198 | 191 |
| [g/L] | | | | | | |
| Dry density | 121 | 132 | 137 | 145 | 128 | 124 |
| [g/L] | | | | | | |
| Compressive | 31 | 91 | 42 | 147 | 32 | 93 |
| strength | | | | | | |
| [kPa] | | | | | | |
| Thermal | 38.7 | 42.0 | 38.3 | 40.5 | 38.3 | 40.2 |
| conductivity | | | | | | |
| [mW/m · K] | | | | | | |

The apparent higher compressive strengths of the slag samples Ex. 4 and 5 seems to be mainly due to the higher densities thereof. The main disadvantages of Ex. 2, 3, 4 and 5 is to be seen in the crack formation of the respective samples.

1. A geopolymer foam formulation comprising:
a pozzolanic binder selected from metakaolin, microsilica and mixtures thereof;
at least one pulverulent burnt clay material;
at least one alkaline activator selected from the group consisting of alkali metal hydroxides, alkali metal carbonates, alkali metal aluminates, alkali metal silicates and mixtures thereof;
at least one surfactant of the alkyl polyglucoside type;
a gas phase and
water.

2. The geopolymer foam formulation according to claim 1, wherein the pulverulent burnt clay material comprises from 30 to 75% by weight of SiO₂ and from 5 to 35% of Al₂O₃.

3. The formulation according to claim 1, wherein the pozzolanic binder is a mixture of metakaolin and microsilica.

4. The formulation according to claim 1, wherein the pulverulent burnt clay material is brick dust.

5. The formulation according to claim 1, wherein the pulverulent burnt clay material has a d₉₀-value below 1350 μm and a d₅₀-value below 600 μm, as measured by laser granulometry.

6. The formulation according to claim 1, wherein the alkaline activator is selected from alkali metal hydroxides of the formula MOH and alkali metal silicates of the formula m SiO₂·n M₂O, wherein M stands for Li, Na, or K, or a mixture thereof, and the molar ratio m:n is ≤4.0.

7. The formulation according to claim 1, wherein the alkaline activator comprises a mixture of alkali metal hydroxides and of alkali metal silicates.

8. The formulation according to claim 1, wherein the alkyl polyglucoside has the formula H—(C₆H₁₀O₅)ₘ—O—R′, where (C₆H₁₀O₅) is a glucose unit, R′ is a C₆₋₁₈-alkyl group, and m is from 1 to 5.

9. The formulation according to claim 1, wherein the gas phase is selected from the group consisting of air, oxygen, hydrogen, nitrogen, a noble gas, hydrocarbons and mixtures thereof.

10. The formulation according to claim 1, wherein from 20 to 95% by volume of the formulation consists of the gas phase.

11. The formulation according to claim 1, wherein the formulation comprises from 10 to 60% by weight of water.

12. The formulation according to claim 1, wherein the formulation comprises up to 20% by weight of a cement.

13. The formulation according to claim 1, wherein
all of the constituents are present together as a single component, or
all solid constituents of the formulation are held in a first, solid component and the water is held in a second, liquid component, or
the pozzolanic binder and the pulverulent burnt clay material are held in a first, solid component and the at least one alkaline activator and the water are held in a second, liquid component.

14. The formulation according to claim 1, wherein the formulation also comprises at least one additive for foam stabilization, shrinkage reduction, flexibilization, hydrophobization, or dispersion; as well as fibers, fillers, or mixtures thereof.

15. The formulation according to claim 1, wherein the formulation comprises:
from 5 to 50% by weight of metakaolin and/or microsilica,
from 5 to 50% by weight of the pulverulent burnt clay material,
from 1 to 55% by weight of alkaline activator (calculated as solids),
from 10 to 50% by weight of water (total quantity),
from 0.01 to 5% by weight of surfactant and a gas phase.

16. A process for the manufacture of the formulation according claim 1,
comprising the steps of:
mixing all solid and liquid components of the formulation and
introducing the gas phase by means of mechanical and/or chemical foaming.

17. A process according to claim 16, additionally comprising the step of:
allowing the formulation to harden and optionally to dry.

18. A geopolymer foam element comprising the hardened geopolymer foam according to claim 17.

19. The geopolymer foam formulation according to claim 1, wherein there are no fly ashes in the geopolymer foam formulation.
